(19) United States
(12) Patent Application Publication
(10) Pub. No.: US 2015/0256977 A1
(43) Pub. Date: Sep. 10, 2015

(54) Determining Activity Paths from Anonymous Application Usage Data and Motion Activity

(71) Applicant: Apple Inc., Cupertino, CA (US)

(72) Inventor: Ronald K. Huang, San Jose, CA (US)

(21) Appl. No.: 14/500,906

(22) Filed: Sep. 29, 2014

Related U.S. Application Data
(60) Provisional application No. 61/947,920, filed on Mar. 4, 2014.

(51) Int. Cl. H04W 4/02

(52) U.S. Cl. CPC H04W 4/028; H04W 88/02

(57) ABSTRACT

Anonymous application usage data (and optionally motion activity classification) are collected on mobile devices and transmitted to a server computer. The anonymous application usage data, which are associated with an application running on the mobile devices, are processed by one or more server computers to determine one or more activity paths. Frequency of usage of the activity paths can also be determined from anonymous application usage data.

### CROSS-REFERENCE TO RELATED APPLICATIONS

This application claims priority to U.S. Provisional Patent Application No. 61/947,920, entitled “Determining Activity Paths from Anonymous Application Usage Data and Motion Activity,” filed Mar. 4, 2014, the entire contents of which are incorporated herein by reference.

### TECHNICAL FIELD

This disclosure relates generally to mapping applications for mobile devices.

### BACKGROUND

Many modern mobile devices (e.g., a smart phone) include a navigation system. The navigation system can include a microprocessor that executes a software navigation or map application that uses data from one or more inertial navigation sensors (e.g., accelerometer, gyro, magnetometer) and a positioning system (e.g., satellite-based, network-based) to determine the current location and direction of travel of the mobile device. The navigation application allows a user to input a desired destination and calculate a route from the current location to the destination according to the user's preferences. A map display includes markers to show the current location of the mobile device, the desired destination and points of interest (POIs) along the route. Some navigation applications can provide a user with turn-by-turn directions. The directions can be presented to the user on the map display and/or by a navigation assistant through audio output. Map information can be presented to the user based on the user's mode of transportation, such as walking, driving or taking mass transit.

Some mobile devices can be worn or held by the user during physical activity (e.g., jogging, biking) These devices include smart phones, media players and wearable devices (e.g., wristwatch or band). Fitness applications can be run on the mobile devices that use sensors (e.g., accelerometer) to measure stride, distance or other parameters to provide fitness information to the user, such as distance traveled, calories burned and heart rate.

### SUMMARY

Anonymous application usage data (and optionally motion activity classification) are collected on mobile devices and transmitted to a server computer. The anonymous application usage data, which are associated with an application running on the mobile devices, are processed by one or more server computers to determine one or more activity paths. For example, when a monitored application (e.g., Nike+™) associated with an activity is launched on a mobile device, location data, timestamp and application identifier are transmitted to one or more server computers. Anonymous application usage data (and optionally motion activity classification) for the monitored application are collected from a plurality of mobile devices (e.g., by crowdsourcing). If there are a threshold number of data points received for the monitored application and the location of those data points span a geographic region, then an activity path (e.g., walking path) is generated for that geographic region and associated with the monitored application.

In some implementations, a method comprises: receiving anonymous application usage data from a plurality of mobile devices, where the anonymous application usage data is associated with an application running on the mobile devices and includes location data for the mobile devices; and determining an activity path based on the anonymous application usage data.

In some implementations, a computing device comprises: one or more processors; memory coupled to the one or more processors and configured for storing instructions, which, when executed by the one or more processors, causes the one or more processors to perform operations comprising: receiving anonymous application usage data from a plurality of mobile devices, where the anonymous application usage data is associated with an application running on the mobile devices and includes location data for the mobile devices; and determining an activity path based on the anonymous application usage data.

Other implementations are directed to systems, devices and computer-readable mediums. Particular implementations disclosed herein provide one or more of the following advantages. Mapping and other applications (e.g., fitness applications) can provide users of mobile devices with activity paths and associated data (e.g., frequency of activity path usage) that is not provided by conventional map databases, mobile mapping applications or online services.

The details of the disclosed implementations are set forth in the accompanying drawings and the description below. Other features, objects and advantages are apparent from the description, drawings and claims.

### DESCRIPTION OF DRAWINGS

FIG. 1 illustrates an example operating environment for determining activity paths based on anonymous application usage data.

FIG. 2 illustrates an example process for determining activity paths based on anonymous application usage data.

FIG. 3 is a block diagram of example device architecture for implementing the features and processes described in reference to FIGS. 1 and 2.

FIG. 4 is a block diagram of an example operating environment for devices having the architecture shown in FIG. 3.

The same reference symbol used in various drawings indicates like elements.

### DETAILED DESCRIPTION

### Example Operating Environment

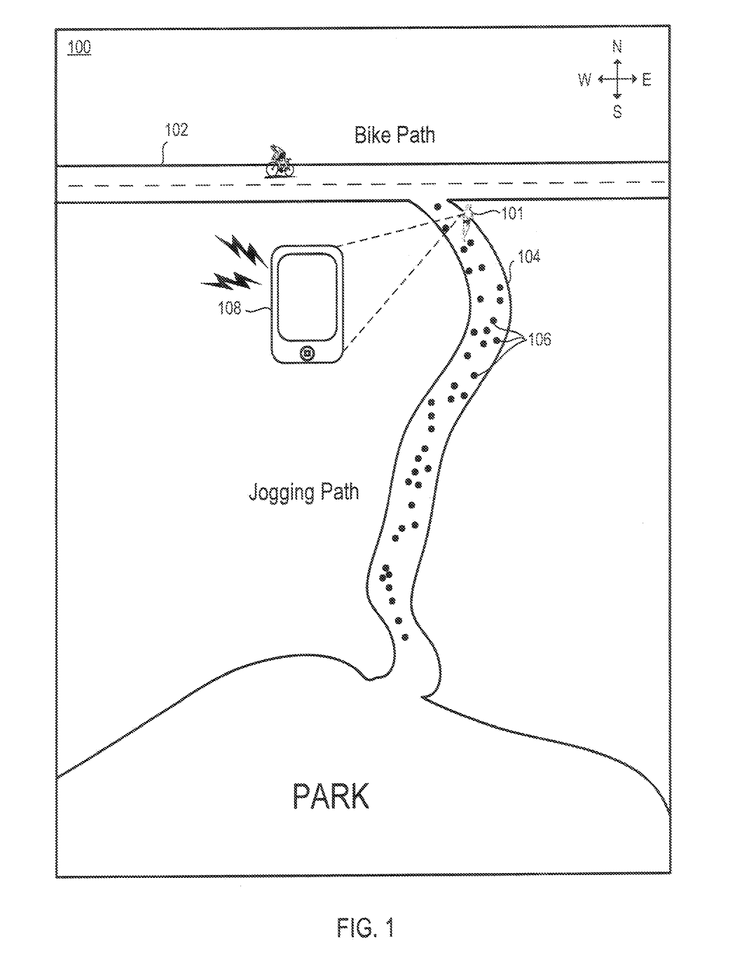

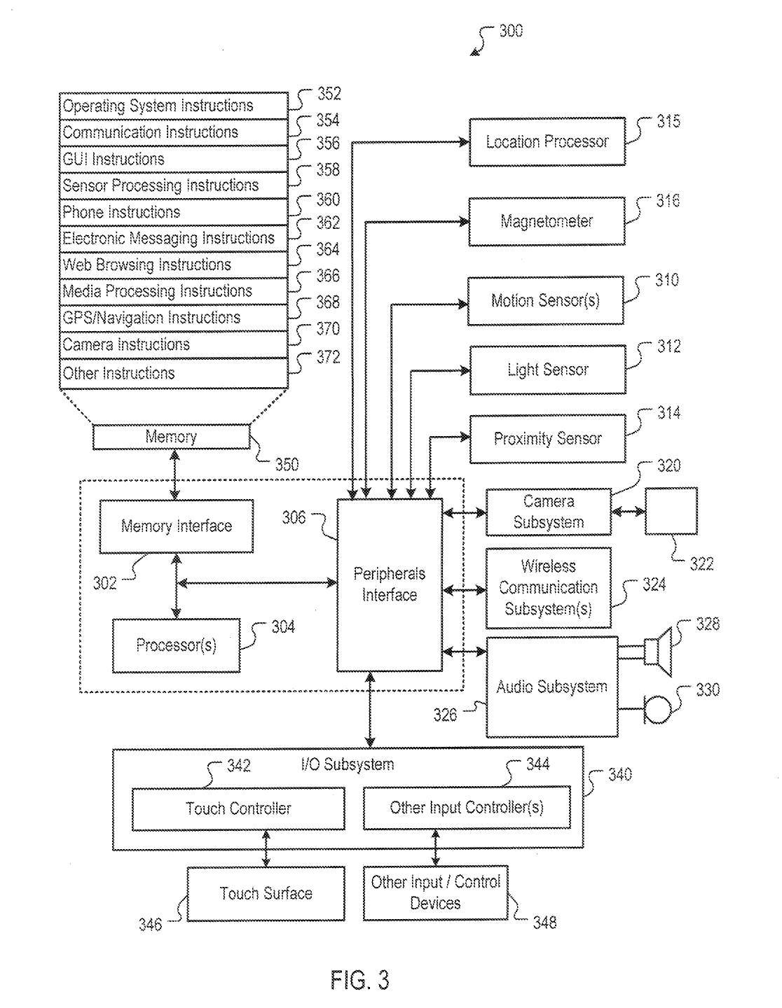

FIG. 1 illustrates a map view of an example operating environment 100 for discovering activity paths based on anonymous application usage data. Operating environment 100 can be any geographic region around the world where humans are engaged in physical activities, including but not limited to: walking, hiking, jogging, running, biking, boating and snowboarding. In the example shown, operating environment 100 is a park that includes bike path 102 and jogging path 104. User 101 is jogging along jogging path 104. User 101 is wearing a device 108, such as a media player or smart phone fastened to the user's arm with an armband. Device 108 includes positioning technology, such as a Global Positioning System (GPS) receiver chip. Device 108 can include mobile device architecture 300 as described in reference to FIG. 3.

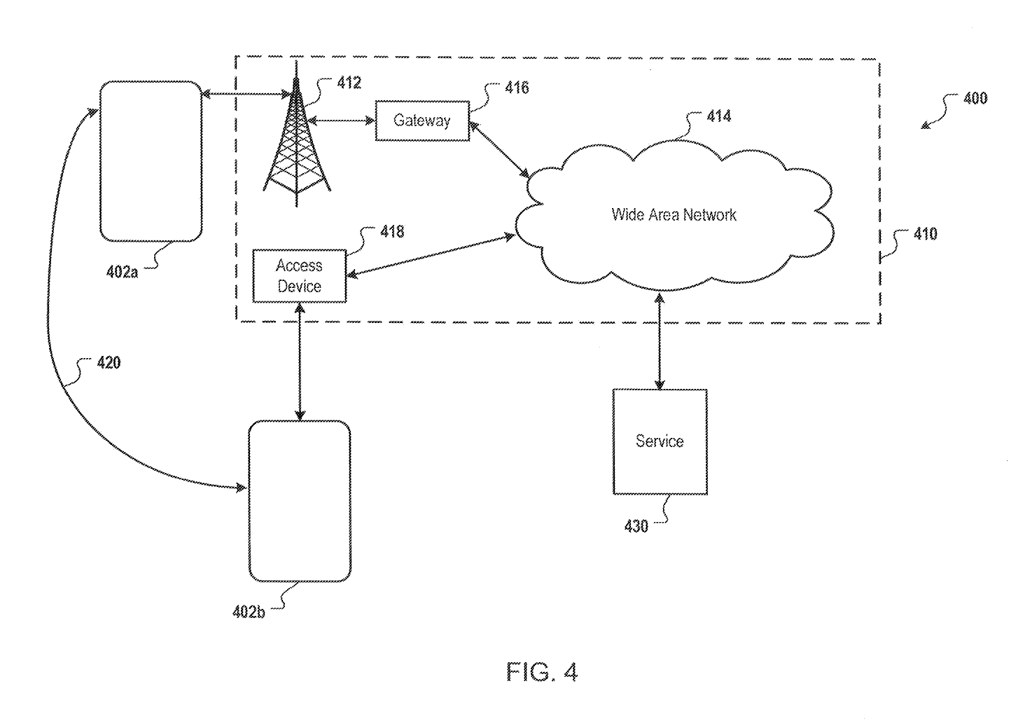

Device 108 includes an application that can determine the current geographic location of the user and whether the user is currently running a monitored application on the device. Device 108 sends anonymous application usage data to one or more server computers coupled to device 108 through wireless and/or wired networks (e.g., cellular network, Internet) using known communication protocols (e.g., 3G, 4G, GPRS), as described in more detail in reference to FIG. 4. The anonymous application usage data can be sent on a scheduled basis or in response to a trigger event. The anonymous application usage data can include the name and/or an identifier for the monitoring application, a timestamp indicating the time that the data was sent to the server computer and the current location (e.g., latitude, longitude, altitude) of device 108. The anonymous application usage data can be sent in a data packet by a daemon running on one or more processors of device 108, for example, as a background process that is transparent to user 101. In the example shown, the black dots 106 represent locations on jogging path 104 where anonymous application usage data has been sent to one or more server computers by a plurality of mobile devices, including device 108. As used herein, the term “anonymous” means the application usage data sent to the one or more server computers does not include data that could be used to identify user 101 of device 108. In some implementations, user 101 can be provided with a mechanism (e.g., a virtual button) on device 108 for opting out of sending anonymous application usage data to the one or more server computers.

At the one or more server computers, the anonymous application usage data can be aggregated and processed to determine an activity path. For example, a large number of users running a monitored application that spans a geographic region may indicate an activity path. Using the current example, anonymous application usage data from the Nike+™ application can be collected from a pool of runners using a technique often referred to as crowdsourcing. If a large number of data points span a geographic region, then an activity path can be generated for that geographic region, which in this example is jogging path 104. The activity path can be designated as a jogging path and data defining or describing the activity path can be stored in one or more databases coupled to the one or more server computers. The stored activity path data can then be served to client devices operated by users who are searching for a nearby jogging path.

A map application running on device 108 can present the activity path in a map display of device 108 or in response to a query or request from another device. In some implementations, the activity path can be presented on the map display as an overlay that is colored or otherwise visually embellished to distinguish the path from routes and points of interest.

In some implementations, the activity path can be generated by fitting one or more lines and polynomial curves to the anonymous application usage data points. For example, principal curve analysis can be used to estimate an activity path from the data points, as described in Brunsdon, Chris, “Path estimation from GPS tracks.” In Proceedings of the 9th International Conference on Geo Computation, National Centre for Geocomputation, National University of Ireland, Maynooth, Eire. 2007, which publication is incorporated by reference herein in its entirety. Once the activity path is generated, the path can be associated (e.g., tagged) with the activity defined by the anonymous application usage data used to generate the activity path. In some implementations, location data points may have to be reduced, de-noised and/or outlier location data points removed from the data set before the activity path is generated. The contours of the generated activity path can be specified by geographic coordinates (e.g., latitude, longitude, altitude), which can be stored in a database coupled to a server computer for subsequent delivery to client devices requesting the data.

In some implementations, after de-noising and removing outliers, one or more smoothing filters can be applied to the location data points and a path direction can be determined from the smoothed location data points. For example, a vector indicating the path's current direction (e.g., the direction of user traffic flow) can be computed using two or more consecutive (consecutive in time) location data points. If a second or next point deviates the current path direction by more than x degrees (e.g., 15°), then the second point can be used as a pivot point for extending the path in a new direction. Otherwise the path can be extended further in the current direction.

In some implementations, the monitored application can be any software program that runs on the device and has been designated for monitoring. For example, popular fitness applications for running (e.g., Nike+™) or biking (e.g., Strava™) can be monitored applications. Ideally, the monitored applications are popular applications that have many end users to maximize the number of anonymous application usage data points that can be harvested from devices. The monitoring applications can be preinstalled on device 108 or downloaded from, for example, an online resource.

In some implementations, the usage frequency of the activity path can be determined from the locations and timestamps provided in the anonymous application usage data. For example, timestamps that fall on a day of the week (Monday-Friday) or in time range (e.g., 2:00 PM-3:00 PM) and that are associated with a high or low number of data points can be used to identify days and time spans where the activity path is crowded or not crowded. A user may find such information useful when planning to use the activity path. A frequency of use metric can be presented to the user in any desirable manner, including in text or graphics or by changing the color of the activity path on a map display. For example, an activity path that is crowded can be red and an activity path that is not crowded can be green. The degree of congestion can be based on some threshold number of data points that can be determined empirically.

### Example Process

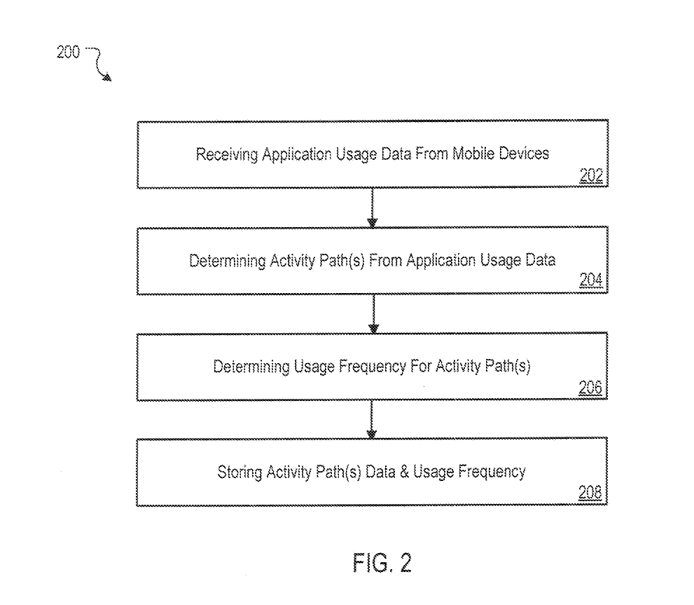

FIG. 2 illustrates an example process for determining activity paths based on anonymous application usage data. Process 200 can be implemented by device architecture 300, as described in reference to FIG. 3.

In some implementations, process 200 can begin by receiving anonymous application usage data from a plurality of mobile devices (202). Mobile devices can include smartphones, e-tablets, wearable devices and another device capable of providing its location information. Anonymous application usage data can include data indicating the type or name of the application, a time stamp indicating when the date was sent to one or more server computers and location data (e.g., latitude, longitude, altitude). The data can be sent in a data packet to the one or more server computers using a daemon running on the device.

Process 200 can continue by determining one or more activity paths from the anonymous application usage data (204). The anonymous application usage data indicates that a particular application that is known to be associated with an activity is being used frequently in a specific geographic region. Primary curve analysis or other known techniques can be used to generate an activity path from the location data included with the anonymous application usage data.

Optionally, usage frequency of the activity path can be determined (206). In some implementations, the usage frequency of the activity path can be determined from the locations and timestamps provided in the anonymous application usage data. For example, timestamps that fall on a day of the week (Monday-Friday) or in time range (e.g., 2:00 PM-3:00 PM) and that are associated with a high or low number of data points can be used to identify days and time spans where the activity path is crowded or not crowded.

In some implementations, motion activity classification can be included with the anonymous application usage data which can provide a clue on what activity the user is engaged in. For example, patterns in accelerometer data can be used to determine a motion activity class that indicates whether the user is walking, running or biking Lower accelerations suggest that the user is walking and higher accelerations suggest that the user is running or biking The motion activity classification can be used to confirm that the activity path is being used for the activity specified by the anonymous application usage data.

Process 200 can continue by storing the one or more activity paths (208). The coordinates of the activity path(s) and the name or other data identifying the path and the associated activity can be stored in a database coupled to a server computer for subsequent delivery to client devices. If usage frequency data is available, such data can also be stored in the database.

### Example Mobile Device Architecture

FIG. 3 is a block diagram of example device architecture for implementing the features and processes described in reference to FIGS. 1 and 2. Architecture 300 may be implemented in any device for generating the features described in reference to FIGS. 1 and 2, including but not limited to portable computers, smart phones and electronic tablets, game consoles, wearable devices and the like. Architecture 300 may include memory interface 302, data processor(s), image processor(s) or central processing unit(s) 304, and peripherals interface 306. Memory interface 302, processor(s) 304 or peripherals interface 306 may be separate components or may be integrated in one or more integrated circuits. One or more communication buses or signal lines may couple the various components.

Sensors, devices, and subsystems may be coupled to peripherals interface 306 to facilitate multiple functionalities. For example, motion sensor 310, light sensor 312, and proximity sensor 314 may be coupled to peripherals interface 306 to facilitate orientation, lighting, and proximity functions of the device. For example, in some implementations, light sensor 312 may be utilized to facilitate adjusting the brightness of touch surface 346. In some implementations, motion sensor 310 (e.g., an accelerometer, gyros) may be utilized to detect movement and orientation of the device. Accordingly, display objects or media may be presented according to a detected orientation (e.g., portrait or landscape).

Other sensors may also be connected to peripherals interface 306, such as a temperature sensor, a biometric sensor, or other sensing device, to facilitate related functionalities.

Location processor 315 (e.g., GPS receiver) may be connected to peripherals interface 306 to provide geo-positioning. Electronic magnetometer 34 (e.g., an integrated circuit chip) may also be connected to peripherals interface 306 to provide data that may be used to determine the direction of magnetic North. Thus, electronic magnetometer 316 may be used as an electronic compass.

Camera subsystem 320 and an optical sensor 322, e.g., a charged coupled device (CCD) or a complementary metal-oxide semiconductor (CMOS) optical sensor, may be utilized to facilitate camera functions, such as recording photographs and video clips.

Communication functions may be facilitated through one or more communication subsystems 324. Communication subsystem(s) 324 may include one or more wireless communication subsystems. Wireless communication subsystems 324 may include radio frequency receivers and transmitters and/or optical (e.g., infrared) receivers and transmitters. Wired communication system may include a port device, e.g., a Universal Serial Bus (USB) port or some other wired port connection that may be used to establish a wired connection to other computing devices, such as other communication devices, network access devices, a personal computer, a printer, a display screen, or other processing devices capable of receiving or transmitting data.

The specific design and implementation of the communication subsystem 324 may depend on the communication network(s) or medium(s) over which the device is intended to operate. For example, a device may include wireless communication subsystems designed to operate over a global system for mobile communications (GSM) network, a GPRS network, an enhanced data GSM environment (EDGE) network, 802.x communication networks (e.g., Wi-Fi, Wi-Max), code division multiple access (CDMA) networks, and a Bluetooth™ network. Communication subsystems 324 may include hosting protocols such that the device may be configured as a base station for other wireless devices. As another example, the communication subsystems may allow the device to synchronize with a host device using one or more protocols, such as, for example, the TCP/IP protocol, HTTP protocol, UDP protocol, and any other known protocol.

Audio subsystem 326 may be coupled to a speaker 328 and one or more microphones 330 to facilitate voice-enabled functions, such as voice recognition, voice replication, digital recording, and telephony functions.

I/O subsystem 340 may include touch controller 342 and/or other input controller(s) 344. Touch controller 342 may be coupled to a touch surface 346. Touch surface 346 and touch controller 342 may, for example, detect contact and movement or break thereof using any of a number of touch sensitivity technologies, including but not limited to capacitive, resistive, infrared, and surface acoustic wave technologies, as well as other proximity sensor arrays or other elements for determining one or more points of contact with touch surface 346. In one implementation, touch surface 346 may display virtual or soft buttons and a virtual keyboard, which may be used as an input/output device by the user.

Other input controller(s) 344 may be coupled to other input/control devices 348, such as one or more buttons, rocker switches, thumb-wheel, infrared port, USB port, and/or a pointer device such as a stylus. The one or more buttons (not shown) may include an up/down button for volume control of speaker 328 and/or microphone 330.

In some implementations, device 300 may present recorded audio and/or video files, such as MP3, AAC, and MPEG files. In some implementations, device 300 may include the functionality of an MP3 player and may include a pin connector for tethering to other devices. Other input/output and control devices may be used.

Memory interface 302 may be coupled to memory 350. Memory 350 may include high-speed random access memory or non-volatile memory, such as one or more magnetic disk storage devices, one or more optical storage devices, or flash memory (e.g., NAND, NOR). Memory 350 may store operating system 352, such as Darwin, RTXC, LINUX, UNIX, OS X, WINDOWS, or an embedded operating system such as VxWorks. Operating system 352 may include instructions for handling basic system services and for performing hardware dependent tasks. In some implementations, operating system 352 may include a kernel (e.g., UNIX kernel).

Memory 350 may also store communication instructions 354 to facilitate communicating with one or more additional devices, one or more computers or servers. Communication instructions 354 may also be used to select an operational mode or communication medium for use by the device, based on a geographic location (obtained by the GPS/Navigation instructions 368) of the device. Memory 350 may include graphical user interface instructions 356 to facilitate graphic user interface processing, including a touch model for interpreting touch inputs and gestures; sensor processing instructions 358 to facilitate sensor-related processing and functions; phone instructions 360 to facilitate phone-related processes and functions; electronic messaging instructions 362 to facilitate electronic-messaging related processes and functions; web browsing instructions 364 to facilitate web browsing-related processes and functions; media processing instructions 366 to facilitate media processing-related processes and functions; GPS/Navigation instructions 368 to facilitate GPS and navigation-related processes, such as the processes described in reference to FIGS. 1 and 2; camera instructions 370 to facilitate camera-related processes and functions; and instructions 372 for implementing some or all of the features and processes described in reference to FIGS. 1 and 2.

Each of the above identified instructions and applications may correspond to a set of instructions for performing one or more functions described above. These instructions need not be implemented as separate software programs, procedures, or modules. Memory 350 may include additional instructions or fewer instructions. Furthermore, various functions of the device may be implemented in hardware and/or in software, including in one or more signal processing and/or application specific integrated circuits.

### Example Operating Environment

FIG. 4 is a block diagram of an example operating environment for devices having the architecture shown in FIG. 3. Mobile devices 402a and 402b can, for example, communicate over one or more wired and/or wireless networks 410 in data communication. For example, a wireless network 412, e.g., a cellular network, can communicate with a wide area network (WAN) 414, such as the Internet, by use of a gateway 416. Likewise, an access device 418, such as an 802.11 g wireless access point, can provide communication access to the wide area network 414. Each of mobile devices 402a and 402b can be mobile device 108.

In some implementations, both voice and data communications can be established over wireless network 412 and the access device 418. For example, mobile device 402a can place and receive phone calls (e.g., using voice over Internet Protocol (VoIP) protocols), send and receive e-mail messages (e.g., using Post Office Protocol 3 (POP3)), and retrieve electronic documents and/or streams, such as web pages, photographs, and videos, over wireless network 412, gateway 416, and wide area network 414 (e.g., using Transmission Control Protocol/Internet Protocol (TCP/IP) or User Datagram Protocol (UDP)). Likewise, in some implementations, the mobile device 402b can place and receive phone calls, send and receive e-mail messages, and retrieve electronic documents over the access device 418 and the wide area network 414. In some implementations, mobile device 402a or 402b can be physically connected to the access device 418 using one or more cables and the access device 418 can be a personal computer. In this configuration, mobile device 402a or 402b can be referred to as a “tethered” device.

Mobile devices 402a and 402b can also establish communications by other means. For example, wireless device 402a can communicate with other wireless devices, e.g., other mobile devices, cell phones, etc., over the wireless network 412. Likewise, mobile devices 402a and 402b can establish peer-to-peer communications 420, e.g., a personal area network, by use of one or more communication subsystems, such as the Bluetooth™ communication devices. Other communication protocols and topologies can also be implemented.

The mobile device 402a or 402b can, for example, communicate with one or more services or server computers 430 (e.g., mapping or navigation service) over the one or more wired and/or wireless networks. Mobile device 402a or 402b can also access other data and content over the one or more wired and/or wireless networks. For example, content publishers, such as news sites, Really Simple Syndication (RSS) feeds, web sites, blogs, social networking sites, developer networks, etc., can be accessed by mobile device 402a or 402b. Such access can be provided by invocation of a web browsing function or application (e.g., a browser) in response to a user touching, for example, a Web object.

The features described may be implemented in digital electronic circuitry or in computer hardware, firmware, software, or in combinations of them. The features may be implemented in a computer program product tangibly embodied in an information carrier, e.g., in a machine-readable storage device, for execution by a programmable processor; and method steps may be performed by a programmable processor executing a program of instructions to perform functions of the described implementations by operating on input data and generating output.

The described features may be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that may be used, directly or indirectly, in a computer to perform a certain activity or bring about a certain result. A computer program may be written in any form of programming language (e.g., Objective-C, Java), including compiled or interpreted languages, and it may be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors or cores, of any kind of computer. Generally, a processor will receive instructions and data from a read-only memory or a random access memory or both. The essential elements of a computer are a processor for executing instructions and one or more memories for storing instructions and data. Generally, a computer may communicate with mass storage devices for storing data files. These mass storage devices may include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory may be supplemented by, or incorporated in, ASICs (application-specific integrated circuits).

To provide for interaction with an author, the features may be implemented on a computer having a display device such as a CRT (cathode ray tube) or LCD (liquid crystal display) monitor for displaying information to the author and a keyboard and a pointing device such as a mouse or a trackball by which the author may provide input to the computer.

The features may be implemented in a computer system that includes a back-end component, such as a data server or that includes a middleware component, such as an application server or an Internet server, or that includes a front-end component, such as a client computer having a graphical user interface or an Internet browser, or any combination of them. The components of the system may be connected by any form or medium of digital data communication such as a communication network. Examples of communication networks include a LAN, a WAN and the computers and networks forming the Internet.

The computer system may include clients and servers. A client and server are generally remote from each other and typically interact through a network. The relationship of client and server arises by virtue of computer programs running on the respective computers and having a client-server relationship to each other.

One or more features or steps of the disclosed embodiments may be implemented using an Application Programming Interface (API). An API may define one or more parameters that are passed between a calling application and other software code (e.g., an operating system, library routine, function) that provides a service, that provides data, or that performs an operation or a computation.

The API may be implemented as one or more calls in program code that send or receive one or more parameters through a parameter list or other structure based on a call convention defined in an API specification document. A parameter may be a constant, a key, a data structure, an object, an object class, a variable, a data type, a pointer, an array, a list, or another call. API calls and parameters may be implemented in any programming language. The programming language may define the vocabulary and calling convention that a programmer will employ to access functions supporting the API.

In some implementations, an API call may report to an application the capabilities of a device running the application, such as input capability, output capability, processing capability, power capability, communications capability, etc.

As described above, some aspects of the subject matter of this specification include gathering and use of data available from various sources to improve services a mobile device can provide to a user. The present disclosure contemplates that in some instances, this gathered data may identify a particular location or an address based on device usage. Such personal information data can include location-based data, addresses, subscriber account identifiers, or other identifying information.

The present disclosure further contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. For example, personal information from users should be collected for legitimate and reasonable uses of the entity and not shared or sold outside of those legitimate uses. Further, such collection should occur only after receiving the informed consent of the users. Additionally, such entities would take any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices.

In the case of advertisement delivery services, the present disclosure also contemplates embodiments in which users selectively block the use of, or access to, personal information data. That is, the present disclosure contemplates that hardware and/or software elements can be provided to prevent or block access to such personal information data. For example, in the case of advertisement delivery services, the present technology can be configured to allow users to select to “opt in” or “opt out” of participation in the collection of personal information data during registration for services.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users by inferring preferences based on non-personal information data or a bare minimum amount of personal information, such as the content being requested by the device associated with a user, other non-personal information available to the content delivery services, or publically available information.

A number of implementations have been described. Nevertheless, it will be understood that various modifications may be made. The systems and techniques presented herein are also applicable to other electronic text such as electronic newspaper, electronic magazine, electronic documents etc. Elements of one or more implementations may be combined, deleted, modified, or supplemented to form further implementations. As yet another example, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

What is claimed is:

1. A method comprising:
receiving, by one or more server computers, anonymous application usage data from a plurality of mobile devices, where the anonymous application usage data is associated with an application running on the mobile devices and includes location data for the mobile devices; and
determining an activity path based on the anonymous application usage data,
where the method is performed by one or more hardware processors of the one or more server computers.

2. The method of claim 1, where determining the activity path further comprises:
identifying a threshold number of anonymous application usage data points associated with geographic locations that span a geographic region.

3. The method of claim 1, further comprising:
determining usage frequency of the activity path.

4. The method of claim 1, further comprising:
receiving a motion activity classification from one or more of the mobile devices; and
determining an activity path based on the anonymous application usage data and the motion activity classification.

5. The method of claim 4, where the motion activity classification is determined based on patterns in acceleration data.

6. The method of claim 1, where determining an activity path further comprises:
applying principal curve analysis to location data points.

7. The method of claim 1, where determining an activity path comprises smoothing the location data points.

8. The method of claim 1, where determining an activity path comprises determining a path direction.

9. The method of claim 8, where determining a path direction includes determining an angular deviation from a current path direction by comparing two or more consecutive location data points.

10. The method of claim 1, further comprising:
receiving informed consent of a user of the mobile device to provide anonymous application usage data to a server computer; and
configuring the mobile device to send the anonymous application usage data to the server computer.

11. A computing device comprising:
one or more processors;
memory coupled to the one or more processors and configured for storing instructions, which, when executed by the one or more processors, causes the one or more processors to perform operations comprising:
receiving anonymous application usage data from a plurality of mobile devices, where the anonymous application usage data is associated with an application running on the mobile devices and includes location data for the mobile devices; and
determining an activity path based on the anonymous application usage data.

12. The computing device of claim 11, where determining the activity path further comprises:
identifying a threshold number of anonymous application usage data points associated with geographic locations that span a geographic region.

13. The computing device of claim 11, further comprising:
determining usage frequency of the activity path.

14. The computing device of claim 11, further comprising:
receiving a motion activity classification from one or more of the mobile devices; and
determining an activity path based on the anonymous application usage data and the motion activity classification.

15. The computing device of claim 14, where the motion activity classification is determined based on patterns in acceleration data.

16. The computing device of claim 11, where determining an activity path further comprises:
applying principal curve analysis to location data points.

17. The computing device of claim 11, where determining an activity path comprises smoothing the location data points.

18. The computing device of claim 11, where determining an activity path comprises determining a path direction.

19. The computing device of claim 18, where determining a path direction includes determining an angular deviation from a current path direction by comparing two or more consecutive location data points defining the current path.

20. The computing device of claim 11, further comprising:
receiving informed consent of a user of the mobile device to provide anonymous application usage data to a server computer; and
configuring the mobile device to send the anonymous application usage data to the server computer.
